(19) United States
(12) Patent Application Publication
(10) Pub. No.: US 2016/0196566 A1
(43) Pub. Date: Jul. 7, 2016

(54) Methods and Systems of Validating Consumer Reviews

(71) Applicant: MASTERCARD INTERNATIONAL INCORPORATED, Purchase, NY (US)

(72) Inventors: Ashwath Murali, New York, NY (US); Debashis Ghosh, Charlotte, NC (US)

(21) Appl. No.: 14/591,515

(22) Filed: Jan. 7, 2015

(51) Int. Cl. G06Q 30/02

(52) U.S. Cl. CPC G06Q 30/0203

(57) ABSTRACT

Systems and methods are provided for validating reviews, by comparing transaction data for consumers to details included in the reviews. Initially, a request is received to validate a review provided by an individual via a review entity. The review relates to at least one of a product, a service, and a merchant. Payment accounts are then identified for various consumers that match a profile of the individual providing the review, and transaction data in the identified payment accounts are compared to details included in the review (e.g., details of at least one of a product, a service, and a merchant associated with the review, etc.). A validity indicator for the review can then be issued, based on the comparison.

### FIELD

The present disclosure generally relates to methods and systems of validating reviews provided by consumers for products, services, merchants, etc.

### BACKGROUND

This section provides background information related to the present disclosure which is not necessarily prior art.

Consumers are known to purchase products and services from merchants. The products and services are commonly paid for through use of payment accounts, including accounts linked to credit cards, debit cards, or prepaid cards. Prior to, or after, the purchase of such products and services, consumers or others may complete reviews of the products and services, or of the merchants from which the products and services were purchased. The reviews may include descriptions of the products, services and/or merchants, performance evaluations of the products, services and/or merchants, whether good or bad, and various other types of information, which might be useful or useless to subsequent consumers of the products and services or the merchants. Certain merchants, especially Internet merchants, provide consumer reviews of the products and services through their websites, to inform subsequent consumers in making purchase decisions. Further, independent websites are known to provide reviews both of products and services and of merchants, so that consumers may compare different products, services and merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in validating a review of a product, service and/or merchant;

FIG. 2 is a block diagram of an exemplary computing device that may be used in the system of FIG. 1; and

FIG. 3 is an exemplary method, suitable for use with the system of FIG. 1, of validating the review of the product, service and/or merchant.

Corresponding reference numerals indicate corresponding parts throughout the several views of the drawings.

### DETAILED DESCRIPTION

Example embodiments will now be described more fully with reference to the accompanying drawings.

Consumers often purchase products and services through use of payment devices, such that transactions for the products and services are posted to payment accounts associated with the payment devices. Separately, individuals, whether consumers or others, often provide reviews of products, services and/or merchants, such that large numbers of reviews are available from review entities, for example, on the Internet, in advertisements, in other publications, etc. The reviews can affect, whether positively or negatively, consumers' purchasing decisions as to the products, services and/or merchants. Where reviews are not provided from consumers that purchased the products and services being reviewed, or are not from consumers that made purchases at the merchant being reviewed, or where the reviews are planted (e.g., are provided by merchants, manufacturers, or other providers of the products and services as self-serving reviews, etc.), the reviews are less indicative of the actual performance, quality, or other traits of the products, services and/or merchants being reviewed. Systems and methods are provided herein to validate such reviews, to provide an indication to subsequent consumers reading the reviews that the reviews are, in fact, from prior consumers of the products, services and/or merchants, and not planted by other interested parties.

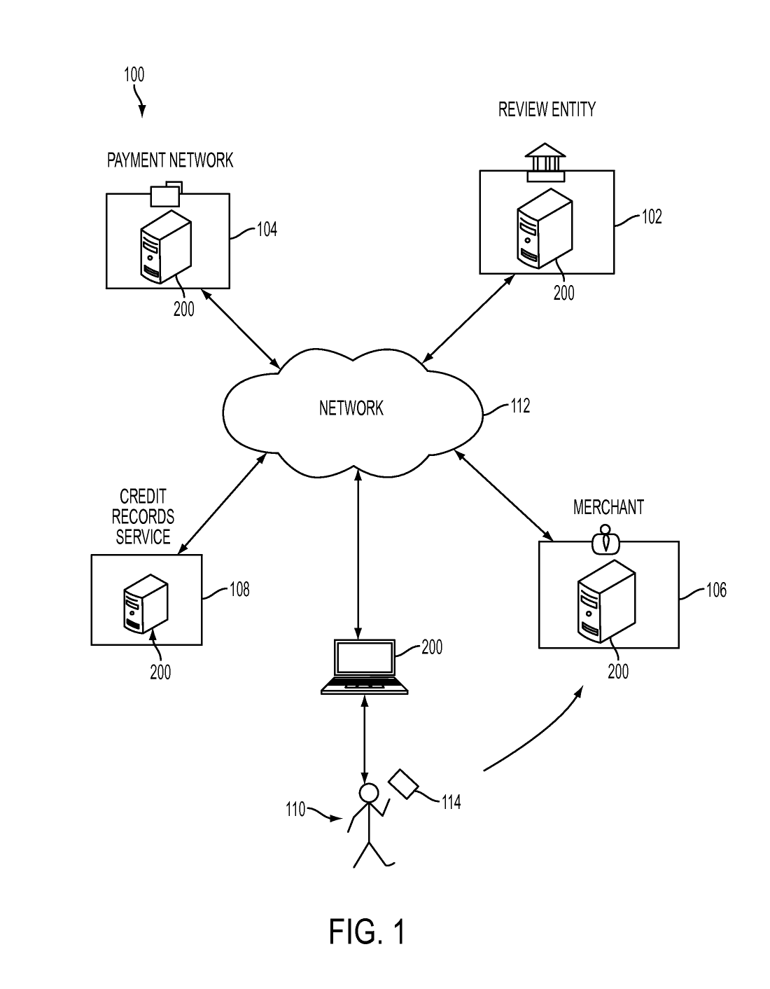

FIG. 1 illustrates an exemplary system 100, in which one or more aspects of the present disclosure may be implemented. For example, the system 100 can be used to validate a review of a product, service and/or merchant, provided by an individual, to thereby confirm that the individual is a consumer who actually purchased the product or service and/or actually was a patron of the merchant. Although components of the system 100 are presented in one arrangement, in FIG. 1, it should be appreciated that other exemplary embodiments may include the same or different components arranged otherwise, for example, depending on arrangement of payment networks, procedures for approving and clearing payment device transactions, identities of and/or interactions between and/or relationships between consumers, merchants, payment networks, review entities, credit records services, etc.

The illustrated system 100 generally includes a review entity 102, a payment network 104 (e.g., MasterCard®, etc.), a merchant 106 (e.g., a physical store, an internet-based merchant, etc.), a credit records service 108, and a consumer 110, each coupled to network 112. The network 112 may include, without limitation, one or more local area networks (LAN), wide area networks (WAN) (e.g., the Internet, etc.), mobile networks, virtual networks, other networks as described herein, and/or other suitable public and/or private networks capable of supporting communication among two or more of the illustrated components, or any combinations thereof. In one example, the network 112 includes multiple networks, where different ones of the multiple networks are accessible to different ones of the illustrated components in FIG. 1.

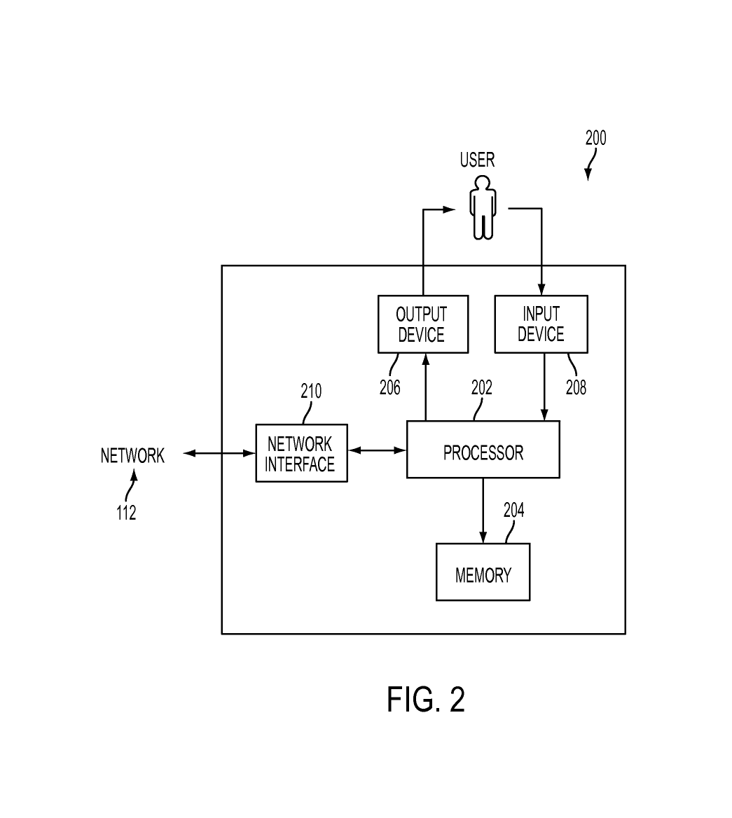

In addition, in the illustrated system 100, each of the review entity 102, the payment network 104, the merchant 106, the credit records service 108, and the consumer 110 are associated with a computing device 200 (which is described more hereinafter with reference to FIG. 2). Each computing device 200 may include a single computing device, or multiple computing devices located together or distributed across a geographic region. Additionally, in some embodiments, each computing device 200 may be coupled to a network (e.g., the Internet, an intranet, a private or public LAN, WAN, mobile network, telecommunication networks, combinations thereof, or other suitable network, etc.) that is part of the network 112, or separate therefrom.

In the system 100, the merchant 106 and the payment network 104 cooperate, in response to the consumer 110, to complete a payment transaction for a product or service. For example, the consumer 110 initiates the transaction by presenting a payment device 114 to the merchant 106 (and, in some cases, entering a personal identification number (PIN) associated with the payment device 114). The payment device 114 may include any suitable device including, for example, a payment card (e.g., a credit card, a debit card, a pre-paid card, etc.), a payment token, a payment tag, a pass, another enabled device used to provide an account number (e.g., a mobile phone, a tablet, etc.), etc.

In response, the merchant 106 reads the payment device 114 and communicates, via the network 112, an authorization request, including details of the payment transaction, to the payment network 104 (via one or more acquirers (not shown)) (e.g., using the MasterCard® interchange, etc.). The authorization request includes various details of the purchase transaction to help facilitate processing the request (e.g., one or more of a consumer account number, a purchase amount, a time/date of the purchase, a merchant identification number (MID), etc.). The payment network 104 stores the authorization request (and associated transaction data) in memory of the computing device 200, and submits the authorization request to an issuer (not shown) associated with the payment device 114. The issuer then provides a response to the authorization request (e.g., authorizing or rejecting the request) to the payment network 104, and the response is provided back through the acquirer to the merchant 106. The transaction is then completed, by the merchant 106, if the response includes an approval.

When the purchase transaction is approved, the merchant 106 next communicates to the payment network 104, via the acquirer, a clearing request (or clearing record) for payment for the purchased product or service from the issuer (at a later time after communicating the authorization request, for example, as part of a batch of multiple different approved transactions for a given time period, etc.). The payment network 104 also stores the clearing request (and associated transaction data) in memory of the computing device 200. The clearing request includes the details of the purchase transaction to help facilitate processing the request (e.g., the same details as included in the authorization request, other details, etc.). The payment network 104, in turn, communicates the clearing request to the issuer, and funds are then transferred to the acquirer for clearing with the merchant 106.

While only one consumer 110 and only one merchant 106 are illustrated in FIG. 1, it should be appreciated that the system 100 can accommodate multiple additional consumers and multiple additional merchants, as desired.

Separately, the credit records service 108 compiles data about consumers (e.g., the consumer 110, other consumers, etc.), from various sources (e.g., from merchants, issuers of lending products, etc.), relating to their prior borrowing and repaying records. Such data is stored in memory of the credit records service computing device 200. In connection with such data, the credit records service 108 provides consumer credit information on individual consumers for various different uses, for example, to the payment network 104 for use in validating reviews as will be described hereinafter, etc. The credit records service 108 can include any suitable service including, for example, Experian™, Equifax™, TransUnion™, Callcredit™, other services, combinations of such services, etc.

Further, and with continued reference to FIG. 1, the review entity 102 of the system 100 compiles reviews of various products and services offered for sale by the merchant 106 as well as reviews of the merchant 106 (in addition to reviews of other products, services and/or merchants). The reviews are published by the review entity 102 and made available to other consumers, for example, on the Internet, or in advertisements, or in other publications, etc., for use in evaluating particular products, services and/or merchants. The review entity 102, as shown in the embodiment of FIG. 1, is a separate review warehouse, such as, for example, an urban city guide (e.g., Yelp®, etc.) or other entity (e.g., Amazon®, etc.). Alternatively, in other embodiments, the review entity 102 is incorporated with one or more of either the merchant 106, the payment network 104, or another entity associated with the payment transaction or with the products and/or services offered for purchase by the merchant 106.

Individuals (e.g., the consumer 110, other consumers, other individuals, etc.) providing the reviews to the review entity 102 are initially required to register with the review entity 102. In addition, upon visiting websites associated with the review entity 102, cookies are generated for the individuals and collected by the review entity 102 (e.g., in memory of computing device 200, by other entities associated with the review entity 102, etc.). With this data (e.g., data collected via registration, data associated with collected cookies, etc.), profiles are generated, by the review entity 102, for each of the individuals. The profiles include various data (e.g., demographic data, other data, etc.) relating to the individuals, that may or may not include personally identifiable information.

An example implementation of the system 100 will be described next. After completing the payment transaction with the merchant 106, the consumer 110 contacts the review entity 102, via computing device 200 and network 112, to provide a review (e.g., a written review, a review selected from predetermined options, etc.) of the product or service purchased from the merchant 106 and/or a review of the merchant 106. In so doing, the consumer 110 initially registers with the review entity 102 (if not already done), and then provides the review (e.g., via computing device 200, etc.). Upon receiving the review, the review entity 102 communicates, via the network 112, a request to the payment network 104 to validate the review. The request includes the profile of the consumer 110 (or various keywords relating to the consumer's profile) which, in this example, includes the consumer's age, gender, and state/country of residence (and does not include personally identifiable information—such that the review entity 102 and the payment network 104 are not aware of the actual identity of the consumer 110 based on the profile).

In connection with the request to validate the consumer's review, the payment network 104 communicates with the credit records service 108, via the network 112, to identify payment accounts of consumers, stored in memory of the credit records service computing device 200, that match the profile of the consumer 110. In response in this example, the credit records service 108 identifies all payment accounts for consumers that are the same age, same gender, and reside in the same state/country as the consumer 110 providing the review (e.g., via geodemographic segmentation, other algorithms, etc.). The identified payment accounts (and, in some embodiments, data for the consumers associated with the payment accounts) are then communicated, via the network, to the payment network 104. It should be appreciated that, in embodiments where personally identifiable information is communicated, hashing or other obfuscation techniques can be used to protect the information.

Next, the payment network 104 compares details included in the review (e.g., date/time of the review, product name, service description, merchant name, MID, etc.) to transaction data in the identified payment accounts (e.g., to determine if the consumers associated with the identified payment accounts were in the general vicinity of the merchant 106 identified in the review (e.g., within a neighborhood, within a mile, within a half mile, within a quarter mile, within a county, within a zip code, within an area code, etc.), or actually performed a transaction at the merchant 106 and/or for the products or services identified in the review). The payment network 104 searches in the identified payment accounts, in memory of the computing device 200 (where the transaction data from the authorization requests and clearing requests are stored), for specific transactions that match the details of the product, service and/or merchant included in review. Matching transactions from the identified payment accounts may include, for example, transactions at the merchant 106 completed within a time frame of when the review is generated, provided, posted, etc. (e.g., within one day, within five days, within one week, etc.); transactions at merchants located within a geographic distance of the merchant 106 (e.g., within one mile, within two miles, within the same zip code, etc.); transactions for the same product or service within a time frame of when the review is generated, provided, posted, etc.; and/or combinations thereof; etc. With that said, it should be appreciated that the actual identity of the consumers associated with the identified payment accounts (and their personally identifiable information), received from the credit records service 108, is not required by the payment network 104 (even though it may be available and/or used in some embodiments).

When one or more matching transactions are found in the identified payment accounts (suggesting that the consumer(s) associated with the matching transaction data from the identified payment account may be the consumer 110 that provided the review), the payment network 104 validates the review and communicates a validity indicator, via the network 112, to the review entity 102. In some embodiments, the review entity 102 may then indicate the published review is validated, so that subsequent consumers are able to quickly identify which of the reviews compiled by the review entity 102 have been validated and, thus, are more likely to provide accurate reviews, being from consumers who have previously purchased the products or services and/or who have previously been patrons of the merchants.

However, when no matching transactions are found in the identified payment accounts (suggesting that the consumer(s) associated with the identified payment accounts may not be the consumer 110 that provided the review), the payment network 104 notifies the review entity 102 that insufficient data is available to validate the review and, in some instances, may actually invalidate the review.

The payment network 104 may also, to the extent permitted by local privacy laws and regulations, utilize cellular data (or probe data) transmitted between mobile devices and cellular towers to determine if various consumers were in the general vicinity of any geographic location identified in the review (e.g., the merchant 106, etc.). The data may include geo-coordinates of the consumers' mobile devices, movement/speed of the consumers' mobile devices, angle/direction of orientation/travel of the consumers' mobile devices, etc., and may be used to establish/validate presence of one or more of the consumers at the geographic location identified in the review. For example, in the system 100, for each of the particular consumers associated with the identified payment accounts, the payment network 104 may request (and subsequently receive) the consumers' cellular data from a cellular service provider associated with the consumers' mobile devices, or another entity. From the cellular data, the payment network 104 can then compare details included in the consumer's review (e.g., a location of the merchant 106, etc.) to the cellular data, to determine if any of the consumers were in the general vicinity of the merchant 106 within an acceptable time frame of the review (suggesting that the consumer(s) associated with the matching cellular data may be the consumer 110 that provided the review).

As another example implementation of the system 100, an individual provides an unfavorable review to the review entity 102 about the merchant 106. The review entity 102 communicates, via the network 112, a request to the payment network 104 to validate the review (e.g., to determine whether or not the individual actually purchased a product or service from the merchant 106, etc.). In response, the credit records service 108 identifies all payment accounts for consumers that match the profile of the individual providing the review, and communicates the identified payment accounts back to the payment network 104. The payment network 104 then, as described above, searches in the identified payment accounts for transactions near the time of the review (e.g., near the time the review was generated, provided, posted, etc.) and/or near the location of the merchant 106. If matching transactions are found, the payment network 104 validates the review, even though the review is unfavorable, and communicates a validity indicator for the review to the review entity 102. However, if no matching transactions are found, the payment network 104 notifies the review entity 102 that insufficient data is available to validate the review and/or invalidates the review.

It should be appreciated that validation of reviews, via the system 100, may be done automatically for all, or substantially all, reviews. Or, validation may be done for only select reviews, for example, reviews from individuals newly registered with the review entity 102, etc. Then, once sufficient reviews for the individuals are validated, the individuals may become trusted providers such that further validation is not required. It should be appreciated that still other criteria may be employed to validate or not validate one or more reviews.

FIG. 2 illustrates exemplary computing device 200, associated with the various entities shown in FIG. 1. It should be appreciated, however, that other computing devices may be associated with one or more entities shown in FIG. 1, in addition to computing device 200 or instead of computing device 200. Further, different components and/or arrangements of components may be used in other computing devices associated with one or more of the entities shown in FIG. 1.

The illustrated computing device 200 includes a processor 202 and a memory 204 that is coupled to the processor 202. The processor 202 may include one or more processing units (e.g., in a multi-core configuration, etc.). The computing device 200 is programmable to perform one or more operations described herein by programming the processor 202 and/or the memory 204. The processor 202 may include, but is not limited to, a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may be configured to store, without limitation, purchase data, transaction data, profile data for individuals providing reviews, and/or other types of data suitable for use as described herein, etc. In addition, the memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. Further, computer-readable media may, in some embodiments, be selectively insertable to and/or removable from the computing device 200 to permit access to and/or execution by the processor 202 (although this is not required).

In various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The computing device 200 also includes an output device 206 and an input device 208 coupled to the processor 202.

The output device 206 outputs information and/or data (e.g., reviews, payment transaction details, payment account details, or any other type of data, etc.) to a user by, for example, displaying, audibilizing, and/or otherwise outputting the information and/or data. In some embodiments, the output device 206 may comprise a display device such that various interfaces (e.g., webpages, etc.) may be displayed at computing device 200, and in particular at the display device, to display such information and/or data, etc. And in some examples, the computing device 200 may also (or alternatively) cause the interfaces to be displayed at a display device of another computing device, including, for example, a server hosting a website having multiple webpages, etc. With that said, the output device 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the output device 206 may include multiple devices.

The input device 208 is configured to receive input from a user. For example, the input device 208 may be configured to receive any desired type of input from the user, for example, as part of creating reviews, validating reviews, viewing other reviews, viewing payment transaction details, payment account details, etc. In the exemplary embodiment, the input device 208 may include, without limitation, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both the output device 206 and the input device 208.

With continued reference to FIG. 2, the computing device 200 also includes a network interface 210 coupled to the processor 202. The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

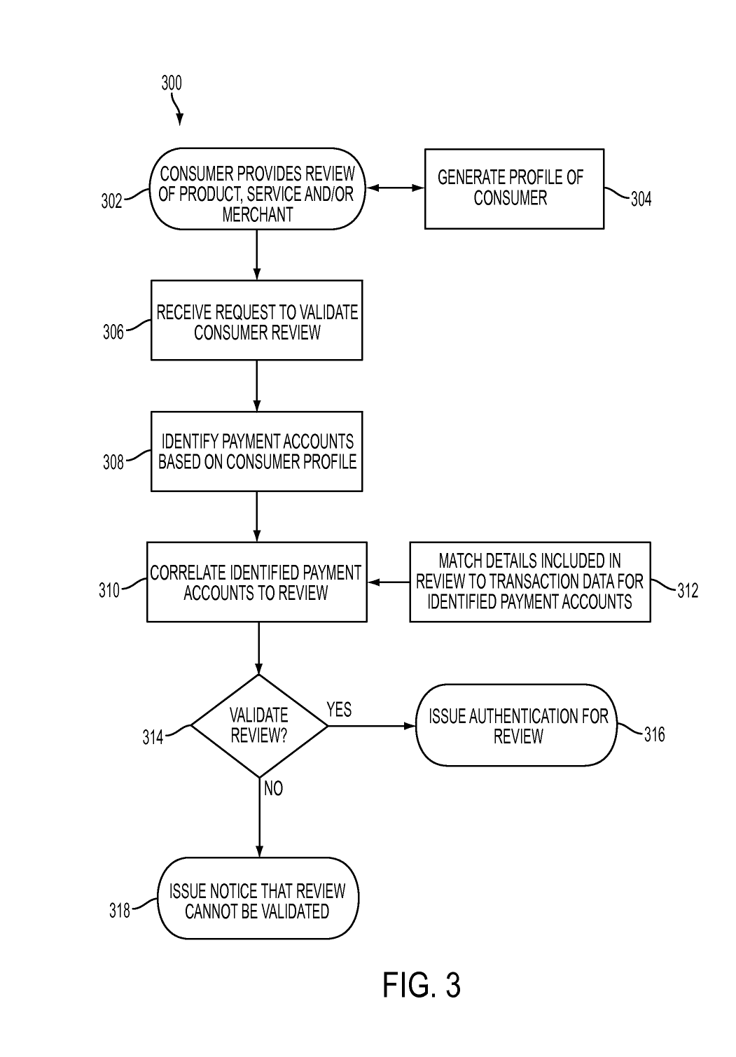

FIG. 3 illustrates an exemplary method 300 of validating reviews of products, services and/or merchants. The method 300 can be implemented in connection with the system 100 of FIG. 1 and is described herein as implemented in the payment network 104 of the system 100 (e.g., in the computing device 200 of the payment network 104, etc.), with further reference to the review entity 102, the merchant 106, the credit records service 108, and the consumer 110. In addition, for purposes of illustration, the exemplary method 300 is described herein with reference to the computing device 200. However, the methods herein should not be understood to be limited to the exemplary system 100, or the exemplary computing device 200. Similarly, the systems and the computing devices herein should not be understood to be limited to the exemplary method 300.

As shown in FIG. 3, after the consumer 110 purchases a product or service from the merchant 106, the consumer 110 decides to author a review, at 302, of the product or service, or of the merchant 106, or of both for a number of reasons, including, for example, experience with the goods, services and/or merchant 106, an incentive to complete the review, an invitation from the review entity 102, the merchant 106, or another associated with the product, service and/or merchant 106, etc. The consumer 110 may initiate the review at a website associated with the merchant 106, with the review entity 102, or with another entity suitable to accept, facilitate, and/or display reviews, for example. In other examples, the review may be initiated by telephone, by the consumer 110, the review entity 102, or another. In still other examples, the consumer 110 may receive an email that solicits the review, and provides a link to the review entity's website. The email may be sent from the review entity 102, the merchant 106, the payment network 104, or another, based on the consumer's purchase of particular goods or services, or visit to a particular merchant, etc. Any number of different factors on the part of the consumer 110, the merchant 106, or others may lead to the consumer 110 being solicited for a review.

Prior to providing the review, the consumer 110 establishes an account with the review entity 102 (e.g., registers with the review entity 102, etc.). In the illustrated method 300, when establishing the account, the review entity 102 causes a review interface to be displayed at the consumer's computing device 200, at the output device 206, requesting various data (e.g., demographic data, etc.) for the consumer 110. The data is processed by the review entity 102 (e.g., by the processor of the review entity computing device 200, etc.) to generate a profile for the consumer 110, at 304, which is stored in memory of the computing device 200. In this embodiment, the data (and thus the profile) includes the consumer's age, gender, and state/country of residence (and does not include, in this embodiment, personally identifiable information—such that the review entity 102 and other parties are not aware of the actual identify of the consumer 110 based on the profile). The consumer 110 then also uses the review interface to provide/submit the review to the review entity 102. It should be appreciated that any suitable interface may be used by the review entity 102 to collect the consumer data and review.

Upon receiving the review, the review entity 102 communicates a request to the payment network 104 to validate the review. And, the request is received by the payment network 104, at 306, via computing device 200. The request includes the profile of the consumer 110, which may be a complete profile, or a partial profile.

In connection with the request to validate the consumer's review, the payment network 104 identifies, at 308, payment accounts of consumers that match the particular profile of the consumer 110 provided by the review entity 102. In the illustrated method 300, this includes communicating with the credit records service 108 to identify the payment accounts. For example, the payment network 104 communicates the profile of the consumer 110 providing the review to the credit records service 108. And, based on the profile, the credit records service 108 identifies payment accounts for available consumers that match the profile (e.g., that are the same age, same gender, and reside in the same state/country as the consumer 110 providing the review, etc.). The identified payment accounts (and, in some embodiments, data for the consumers associated with the payment accounts) are then communicated by the credit records service 108, via the network 112, to the payment network 104.

Next, the payment network 104 flags the identified payment accounts in memory of the payment network computing device 200, and then correlates, at 310, the payment accounts to the review. In the illustrated method 300, this includes comparing, at 312, details included in the review (e.g., date/time of the review, product name, service description, merchant name, MID, etc.) to transaction data in the identified payment accounts. For example, the payment network 104 searches the identified payment accounts, in memory of the computing device 200 (where the transaction data from the authorization requests and clearing requests are stored), for specific transactions that match the details of the product, service and/or merchant included in the review. Such matching transactions suggest that consumer(s) associated with the matching transaction data actually purchased the product or service being reviewed or was a patron at the merchant 106, and thus may be the consumer 110 that provided the review. As previously described, matching transactions from the identified payment accounts may include, for example, transactions at the merchant 106 completed within a time frame of when the review is generated, provided, posted, etc.; transactions at merchants located within a geographic distance of the merchant 106; transactions for the same product or service within a time frame of when the review is generated, provided, posted, etc.; and/or combinations thereof; etc.

When one or more matching transactions are found in the identified payment accounts, the payment network 104 validates the review, at 314, and issues, via processor, a validity indicator, at 316, authenticating the review. However, when no matching transactions are found in the identified payment accounts, at 314, the payment network 104 issues, via processor, a validity indicator, at 318, notifying that the review cannot be validated. Here, the consumer 110 providing the review may have completed the transaction using cash (or other form of payment), or may have provided the review without actually purchasing the product or service at the merchant 106.

In some aspects of the method 300, the payment network 104 may also, to the extent permitted by local privacy laws and regulations, request (and subsequently receive), for each of the particular consumers associated with the identified payment accounts (or simply for the consumers' having matching transactions), the consumers' cellular data from a cellular service provider associated with the consumers' mobile devices, or another entity. From the cellular data, the payment network 104 can then compare details included in the consumer's review (e.g., a location of the merchant 106, etc.) to the cellular data, to determine if any of the consumers were in the vicinity of the merchant 106 within an acceptable time frame of the review (suggesting that the consumer(s) associated with the matching cellular data may be the consumer 110 that provided the review).

In various embodiments, the validity indicator may include a score (e.g., on a scale of one to ten, etc.), indicating a degree of confidence that the consumer 110 providing the review actually purchased the product or service identified in the review, or was a patron of the merchant 106. In these embodiments, the score may be based on the number of transactions found by the payment network 104 to match the details of the review, etc.

As an example, and without limitation, the score may include a number ranging from 1-10. A score of 1 indicates that it is “Least Likely” that any of the identified consumers provided the review, and a score of 10 indicates that it is “Most Likely” that one of the identified consumers provided the review (e.g., were at a location associated with or identified in the review, such as at the merchant 106, etc.). In particular, a score of 10 may be assigned if the payment network 104 finds a transaction by a consumer (e.g., consumer 110, etc.) at the merchant 106 identified in the review at about the same time the review was generated; a score of 7 may be assigned if the payment network 104 finds a transaction by a consumer (e.g., consumer 110, etc.) at a merchant adjacent merchant 106 within an acceptable time frame of when the review was generated; a score of 5 may be assigned if the payment network 104 finds, via cellular data, that one or more identified consumers were present within a general vicinity of the merchant 106; a score of 3 may be assigned by the payment network 104 if any matching payment transactions and/or any matching cellar data was found, regardless of timing, etc.; and a score of 0-1 may be assigned by the payment network 104 if no matching payment transactions or no matching cellular data was found.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a request to validate a review provided by a consumer via a review entity, the review relating to at least one of a product, a service, and a merchant; (b) identifying payment accounts of consumers matching a profile of the consumer providing the review; (c) correlating transaction data in the identified payment accounts to the at least one of the product, the service, and the merchant associated with the review; and (d) issuing a validity indicator for the review based on the correlation.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” or “associated with” another feature, element or layer, it may be directly on, engaged, connected, coupled, or associated with/to the other feature, element or layer, or intervening features, elements or layers may be present. In contrast, when feature, element or layer is referred to as being “directly on,” “directly engaged to,” “directly connected to,” “directly coupled to,” “directly associated with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of validating reviews provided by consumers, the method comprising:
receiving, at a computing device, a request to validate a review provided by a consumer via a review entity, the review relating to at least one of a product, a service, and a merchant;
identifying payment accounts of consumers matching a profile of the consumer providing the review;
correlating transaction data in the identified payment accounts to the at least one of the product, the service, and the merchant associated with the review; and
issuing, by the computing device, a validity indicator for the review based on the correlation.

2. The method of claim 1, wherein the request includes the profile of the consumer providing the review, and wherein the profile includes demographic data for said consumer; and
wherein identifying the payment accounts of the consumers includes identifying the payment accounts of the consumers whose demographic data matches that of the consumer providing the review.

3. The method of claim 2, wherein the demographic data included in the profile of the consumer providing the review includes one or more of data provided by said consumer when establishing an account with the review entity and data associated with cookies created by said consumer via interaction with one or more interfaces supported by the review entity.

4. The method of claim 1, wherein correlating the transaction data in the identified payment accounts to the at least one of the product, the service, and the merchant associated with the review includes searching in the transaction data, by the computing device, for one or more transactions relating to the at least one of the product, the service, and the merchant associated with the review.

5. The method of claim 4, wherein the one or more transactions relating to the at least one of the product, the service, and the merchant associated with the review includes a transaction at the merchant associated with the review.

6. The method of claim 4, wherein the one or more transactions relating to the at least one of the product, the service, and the merchant associated with the review includes a transaction at a location that is geographically similar to a location of the merchant associated with the review.

7. The method of claim 1, wherein the validity indicator includes one or more of a score indicating whether or not the review is valid and an authentication for the review indicating that the review is valid.

8. The method of claim 1, wherein issuing the validity indicator includes communicating, by the computing device, the validity indicator to the review entity.

9. The method of claim 1, further comprising comparing cellular data for mobile devices of the consumers associated with the identified payment accounts to a location of the merchant identified in the review, to determine if one or more of the consumers where in a general vicinity of the merchant's location.

10. A system for validating reviews provided by consumers for products, services, and/or merchants, the system comprising:
a memory configured to store transactions to payment accounts, the transactions associated with one or more of products, services, and merchants;
a processor coupled to the memory, the processor configured to:
receive a request to validate a review, provided by a consumer via a review entity, relating to at least one of a product, a service, and a merchant, the request including a profile of the consumer providing the review;
identify one or more payment accounts of consumers that fit the profile of the consumer providing the review;
identify transaction data in the identified payment accounts, in the memory, that matches at least one of the product, the service, and the merchant associated with the review; and
issue a validity indicator for the review based on the identified transaction data.

11. The system of claim 10, wherein the profile of the consumer providing the review includes demographic data for said consumer; and
wherein the identified payment accounts are associated with consumers whose demographic data matches that of the consumer providing the review.

12. The system of claim 11, wherein the demographic data included in the profile of the consumer providing the review includes one or more of data provided by said consumer when establishing an account with the review entity and data associated with cookies created by said consumer via interaction with one or more interfaces supported by the review entity.

13. The system of claim 10, wherein the identified transaction data includes transaction data relating to a transaction at the merchant associated with the review.

14. The system of claim 10, wherein the identified transaction data includes transaction data relating to a transaction at a location that is geographically similar to a location of the merchant associated with the review.

15. The system of claim 10, wherein the validity indicator includes one or more of a score indicating whether or not the review is valid and an authentication for the review indicating that the review is valid.

16. The system of claim 10, wherein the processor is further configured to:
associate the validity indicator with the review, in the memory; and
transmit the validity indicator to the review entity.

17. A non-transitory computer readable media comprising computer-executable instructions that, when executed by at least one processor, cause the at least one processor to:
identify payment accounts of consumers matching a profile of a consumer providing a review relating to at least one of a product, a service, and a merchant;
match transaction data in the identified payment accounts to the at least one of the product, the service, and the merchant associated with the review; and
issue a validity indicator for the review based on the at least one match between the transaction data in the identified payment accounts and the at least one of the product, the service, and the merchant associated with the review, the validity indicator providing a prediction of whether or not the review is valid.

18. The non-transitory computer readable media of claim 17, wherein the validity indicator includes a score indicating a degree of the at least one match between the transaction data in the identified payment accounts and the at least one of the product, the service, and the merchant associated with the review.

19. The non-transitory computer readable media of claim 18, further comprising computer-executable instructions that, when executed by at least one processor, cause the at least one processor to:
associate the score with the review; and
transmit the score to the review entity for use in determining whether or not the review is valid.

20. The non-transitory computer readable media of claim 17, wherein the matching transaction data in the identified payment accounts includes one or more of transaction data relating to a transaction at the merchant associated with the review and transaction data relating to a transaction at a location that is geographically similar to a location of the merchant associated with the review.
